(19) United States
(12) Patent Application Publication
(10) Pub. No.: US 2010/0001840 A1
(43) Pub. Date: Jan. 7, 2010

(54) METHOD AND SYSTEM FOR AUTHENTICATING RFID TAG

(76) Inventors: You Sung KANG, Daejeon-city (KR); Yong Je CHOI, Daejeon-city (KR); Doo Ho CHOI, Dongnam-gu (KR); Kyo Il CHUNG, Daejeon-city (KR); Hyun Sook CHO, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/498,221

(22) Filed: Jul. 6, 2009

(30) Foreign Application Priority Data
Jul. 7, 2008 (KR) 10-2008-0065597
Apr. 9, 2009 (KR) 10-2009-0030953

(51) Int. Cl. H04Q 5/22

(52) U.S. Cl. 340/10.1

(57) ABSTRACT

Provided are a method and a system for authenticating a radio frequency identification (RFID) tag, by which an RFID reader and an authentication server authenticate the RFID tag by using a cryptographic operation and a protocol.

### CROSS-REFERENCE TO RELATED PATENT APPLICATION

This application claims the benefit of Korean Patent Application Nos. 10-2008-0065597, filed on Jul. 7, 2008 and 10-2009-0030953, filed on Apr. 9, 2009, in the Korean Intellectual Property Office, the disclosure of which is incorporated herein in its entirety by reference.

### BACKGROUND OF THE INVENTION

1. Field of the Invention

The present invention relates to a method and a system by which a radio frequency identification (RFID) reader authenticates a passive RFID tag.

2. Description of the Related Art

Since a passive radio frequency identification (RFID) tag does not have a power source, the passive RFID tag obtains power from an RFID reader. Thus, the passive RFID tag has been simply used to recognize an identification (ID). Operations used in International Organization for Standardization (ISO)/International Electrotechnical Commission (IEC) 18000-6 Type C that is a representative international standard of the passive RFID tag include generating random numbers and performing exclusive OR (XOR) operations. Thus, it is difficult to apply an additional security mechanism.

If cryptographic modules appropriate for passive RFID tags are developed with the development of semiconductor design technology, various security protocols using the cryptographic modules can be realized. In terms of a security service, a protocol is required to provide an interactive authentication service, a tag authentication service, a reader authentication service, a key interchange service, and a data encryption service, and the like between a passive RFID reader and a passive RFID tag.

Different security requirements can be respectively necessary for several applications, but tag authentication is required in an authentication service to authenticate an RFID tag.

According to one general tag authentication method, an RFID reader obtains a master key to perform a process of authenticating an RFID tag. However, if the RFID reader would be a wicked insider, the RFID reader would get knowledge about the master key of the RFID tag. Thus, the RFID reader can reproduce information about the RFID tag and record the reproduced information in another RFID tag. Accordingly, there is required a method of disallowing an RFID reader to know about a master key and allowing the RFID reader to receive only a tag authentication result from an authentication server so that the RFID reader does not attack as a wicked insider.

### SUMMARY OF THE INVENTION

The present invention provides an authentication protocol appropriate for a passive radio frequency identification (RFID) tag and a passive RFID reader.

Other objects and advantages of the present invention will be understood in the description which follows and will be apparent from embodiments of the present invention. Also, it will be easily understood that the other objects and advantages of the present invention will be realized by means and combinations of the means as defined by the following claims.

The present invention provides a method and a system, by which an RFID reader that does not know about a master key authenticates an RFID tag through an authentication server which shares the master key with the RFID tag.

According to an aspect of the present invention, there is provided a method of authenticating an RFID (radio frequency identification) tag having a master key by an RFID reader, including: requesting the RFID tag to transmit a security parameter and receiving a security parameter response from the RFID tag, wherein the RFID generates a session key based on the master key and a first random number; transmitting a challenge to the RFID tag and receiving a challenge-response from the RFID tag; and requesting the RFID tag to transmit authentication data and receiving an authentication data response from the RFID tag.

According to another aspect of the present invention, there is provided a method of authenticating in RFID environment, wherein a RFID tag having a master key is authenticated by an RFID reader, the method including: generating a session key based on the master key and a first random number; receiving a security parameter request from the RFID reader and transmitting a security parameter to the RFID reader; receiving a challenge from the RFID reader and transmitting a challenge-response to the RFID reader; and receiving an authentication data request from the RFID reader and generating authentication data.

According to another aspect of the present invention, there is provided a method by which an authentication server including information about a master key of an RFID tag supports an RFID reader to authenticate the RFID tag having the master key, including: receiving at the authentication server a request to verify authentication data from the RFID reader, wherein the authentication data is generated by the RFID tag; generating authentication data based on the information about the master; and determining whether the RFID tag has been successfully authenticated based on whether authentication data generated by the authentication server is equal to authentication data generated by the RFID tag.

According to another aspect of the present invention, there is provided an RFID reader authenticating an RFID tag having a master key, including: a security parameter obtainer which requests the RFID tag to transmit a security parameter and receives a security parameter response, wherein the RFID tag generates a session key based on the master key and a first random number; a challenge processor which transmits a challenge to the RFID tag and receives a challenge-response ; and an authenticator which requests the RFID tag to transmit authentication data and receives an authentication data response.

According to another aspect of the present invention, there is provided an RFID tag having a master key, including: a key generator which generates a session key based on the master key and a first random number; a security parameter provider which generates a security parameter in response to a security parameter request received from the RFID reader; a challenge processor which generates a challenge-response to a challenge received from the RFID reader; and an authentication data provider which provides authentication data in response to an authentication data request received from the RFID reader.

According to another aspect of the present invention, there is provided an authentication server supporting an RFID reader to authenticate an RFID tag having a master key, including: an operator which receives a request for verifying authentication data generated by the RFID tag from the RFID reader and generates authentication data based on pre-stored information about the master key of the RFID tag; and an authenticator which determines whether the RFID tag has been successfully authenticated based on whether the authentication data is equal to authentication data generated by the RFID tag.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of authenticating a radio frequency identification (RFID) tag according to an embodiment of the present invention;

FIGS. 2A and 2B respectively illustrate a command and a reply “Get_SecParam” according to an embodiment of the present invention;

FIGS. 3A and 3B respectively illustrate a command “Sec_ReqRN” and a reply “Sec_ReqRN” according to an embodiment of the present invention;

FIGS. 4A and 4B respectively illustrate a command “Req_Auth” and a reply “Req_Auth” according to an embodiment of the present invention;

FIG. 5 is a schematic flowchart of a method by which an RFID reader authenticates an RFID tag, according to an embodiment of the present invention;

FIG. 6 is a schematic flowchart of a method by which an RFID tag is authenticated by an RFID reader, according to another embodiment of the present invention;

FIG. 7 is a schematic flowchart of a method by which an authentication server including information about a master key of an RFID tag supports an RFID reader to authenticate the RFID tag having the master key, according to an embodiment of the present invention; and

FIG. 8 is a schematic block diagram of entities of an RFID system by which an RFID reader authenticates an RFID tag by using an authentication server, according to an embodiment of the present invention.

### DETAILED DESCRIPTION OF THE INVENTION

The present invention will now be described more fully with reference to the accompanying drawings, in which exemplary embodiments of the invention are shown. Like reference numerals in the drawings denote like elements. Detailed descriptions of known functions or structures related to the description of the present invention which follows will be omitted if they unnecessarily obscure the concept of the invention.

Also, when any part “includes” any element, this means that the any part may further include another element not except the other element if a particular opposite statement is not made. Terms “ . . . unit,” “ . . . device,” “module,” “block,” or the like described in the specification means a unit which processes at least one function or operation; the unit may be realized as hardware, software, or a combination of hardware and software.

The present invention provides a protocol for authenticating a passive radio frequency identification (RFID) tag. The protocol used in the present invention is compatible with International Organization for Standardization (ISO)/International Electrotechnical Commission (IEC) 18000-6 Type C which is a representative international standard of a passive RFID tag.

The present invention also provides various security services, i.e., tag authentication technology for authenticating an RFID tag, in particular, a protocol through which an RFID reader knows about only a tag authentication result not about a master key of the RFID tag.

In the present invention, when the RFID tag has the master key, and the RIFD reader does not have a master key, the RFID reader receives an authentication message from the RFID tag and transmits the authentication message to an authentication server. Thus, the authentication server verifies authentication data of the RFID tag using the master key and informs the RFID reader of the verification result. Therefore, the verification result can be used to prevent an unauthorized reproduction of tag information performed by the RFID reader and an authentication service for authenticating a product to which a passive RFID tag is attached.

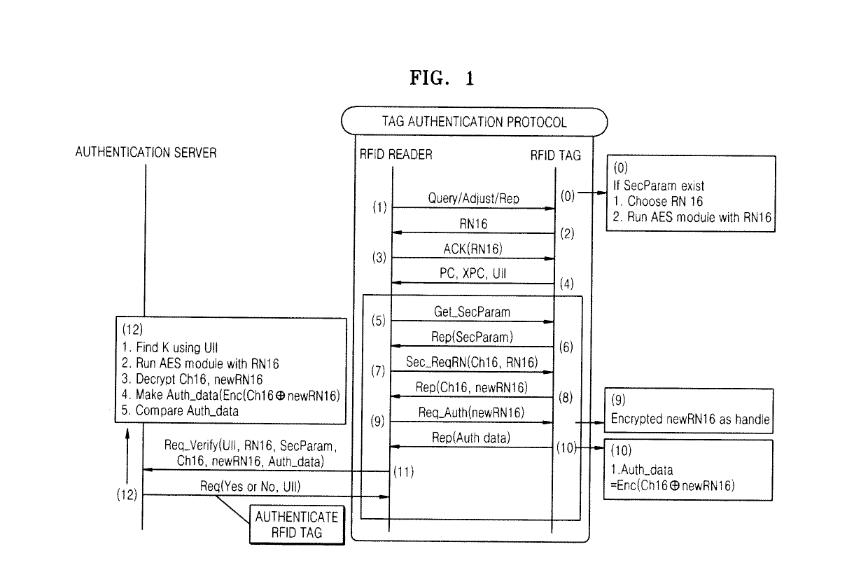

FIG. 1 illustrates a method of authenticating an RFID tag according to an embodiment of the present invention. In the present embodiment, an RFID reader communicates with an authentication server through a stable channel. Also, the RFID tag has a security parameter “SecParam.” The security parameter “SecParam” refers to a structure which includes information related to a cryptographic algorithm which is to be used. However, a detailed description of the security parameter “SecParam” will not be given.

In the present embodiment, the RFID tag stores a master key, the RFID reader does know about the master key of the RFID tag, and only the authentication server includes information about the master key of the RFID tag. The master key is used by the RFID tag only to authenticate the RFID tag.

In operation 0, a security tag having a security parameter “SecParam,” i.e., the RFID tag, generates a random number “RN16” of 16 bits and generates a session key using the random number “RN16” and the master key. Various algorithms may be used to generate the session key. In the present embodiment, an advanced encryption standard (AES) module may be used to perform AES encryption by using encryption algorithm-related information included in the security parameter “SecParam” so as to generate the session key.

Operations 1 through 4 are equal to inventory processes which comply with ISO/IEC 18000-6 Type C. In more detail, in operation 1, the RFID reader transmits a query message to the RFID tag. “Query,” “Query_Adjust,” and “Query_Rep” are commands defined in ISO/IEC 18000-6 Type C, and thus their detailed descriptions will be omitted. In operation 2, the RFID tag receives the query message and transmits the random number “RN16” to the RFID reader. In operation 3, the RFID reader receives the random number “RN16” and transmits an ACK message to the RFID tag. The ACK message refers to a command through which the RFID reader requests the RFID tag to transmit a unique item identification (UII). In operation 4, the RFID tag receives the ACK message from the RFID reader and transmits a protocol control (PC), an eXtended protocol control (XPC), and the UII. The RFID tag transmits its UII as plaintext.

In operation 5, the RFID reader, which is to authenticate the RFID tag according to a security protocol, transmits a command “Get_SecParam” to the RFID tag. Here, the RFID reader does not have the master key and thus cannot generate a session key. Thus, the RFID reader transmits the command “Get_SecParam” as plaintext.

In operation 6, the RFID tag receives the command “Get_SecParam” and transmits the security parameter “SecParam” to the RFID reader.

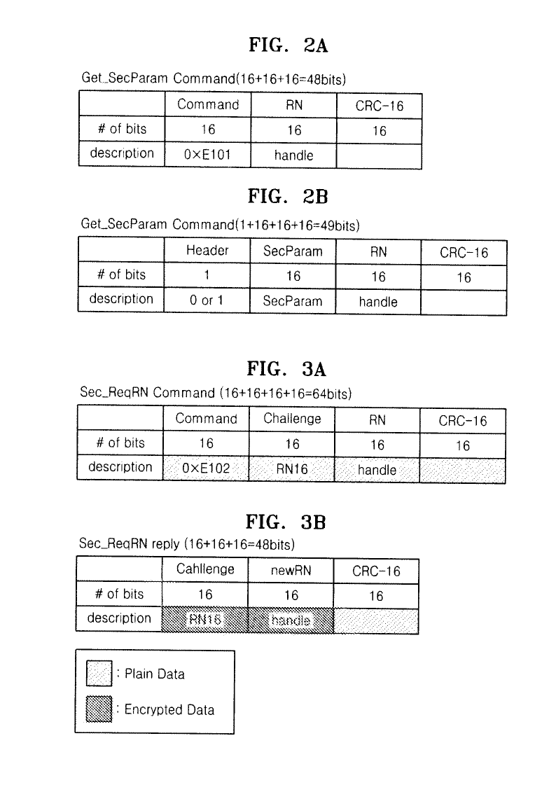

FIG. 2A illustrates a command “Get_SecParam,” and FIG. 2B illustrates a reply “Get_Secparam.” “0xE101 (11100001 00000001₂)” may be used as an example of a code value of the command “Get_Secparam.” The command “Get_Secparam” includes a random number as a handle, and the reply “Get_Secparam” includes a header, the security parameter “SecParam”, and the random number as the handle. The command and reply “Get_SecParam” are transmitted as plaintexts. Here, “CRC-16” of both of the command and replay “Get_SecParam” is not encrypted.

In operation 7, the RFID reader generates a random number “Ch16” which is to be used as a challenge and transmits the random number “Ch16” included in a message “Sec_ReqRN” to the RFID tag. The message “Sec_ReqRN” includes the random number “Ch16” to be used as the challenge and the random number “RN16” received in operation 2 as parameters. The message “Sec_ReqRN” has the random number “RN16” as the parameter and refers to a tag address concept or a session ID concept. In other words, although a plurality of RFID tags receive the message “Sec_ReqRN,” only the RFID tag, which has transmitted the random number “RN16” in operation 2, recognizes the message “Sec_ReqRN” as a message which has been transmitted thereto. A random number used for this purpose is referred to as a handle in ISO/IEC 18000-6 Type C. Since the RFID reader does not know about the master key, the message “Sec_ReqRN” is transmitted as plaintext.

In operation 8, the RFID tag receives the challenge from the RFID reader, encrypts the random number “Ch16” and a new random number “newRN16,” and transmits the encrypted random numbers “Ch16” and “newRN16” to the RFID tag.

FIG. 3A illustrates a command “Sec_ReqRN,” and FIG. 3B illustrates a reply “Sec_ReqRN.” The command “Sec_ReqRN” changes a state of the RFID tag to an open status like a command “Req_RN” defined in ISO/IEC 18000-6 Type C. The command and reply “Sec_ReqRN” refers to operations of transmitting and receiving a challenge and/or response for authenticating the RFID tag. “0xE102” is used an example of a code of the command “Sec_ReqRN,” and the command “Sec_ReqRN” includes a value of a challenge and a value of a random number as a handle and is transmitted as plaintext. The reply “Sec_ReqRN” includes an encrypted value of the challenge and an encrypted value of a new random number. In the command “Sec_ReqRN,” the challenge has a nonce value of 16 bits which are randomly generated by the RFID reader, and a response of the RFID tag has an encrypted value of the challenge received from the RFID reader. “CRC-16” of both the command and the reply “Sec-ReqRN” is not encrypted.

In operation 9, the RFID reader transmits a message “Req_Auth” to the RFID tag to obtain authentication data “Auth_data.” Here, the encrypted new random number “newRN16” received as the handle in operation 8 is used as it is.

In operation 10, the RFID tag transmits the authentication data “Auth_data” to the RFID reader. The RFID tag performs an exclusive OR (XOR) operation on the random number “Ch16” and the new random number “newRN16,” encrypts the resultant value of the XOR operation, generates the authentication data “Auth_data,” and transmits the authentication data “Auth_data” to the RFID reader.

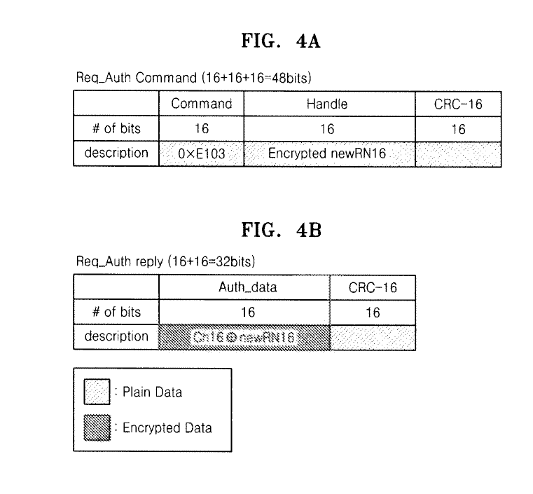

FIG. 4A illustrates a command “Req_Auth,” and FIG. 4B illustrates a reply “Req_Auth.” The command “Req_Auth” is to request authentication data for authenticating the RFID tag. For example, a code of the command “Req_Auth” is “0xE103,” and the RFID reader transmits the command “Req_Auth” as a plaintext, and the RFID tag encrypts the authentication data “Auth_data” and transmits the encrypted authentication data “Auth_data” to the RFID reader. In other words, according to a tag authentication protocol since the RFID reader does not have the master key, a command of the RFID reader may not be encrypted, but the RFID tag may generate a session key and perform an encryption operation using the master key thereof. The encrypted authentication data “Auth_data” transmitted from the RFID tag is transmitted to and decrypted by the authentication server. Here, “CRC-16” of both of the command and reply “Req-Auth” is not encrypted.

In operation 11, the RFID reader ends the communication with the RFID tag and communicates with the authentication server to verify values transmitted from the RFID tag. In other words, the RFID reader transmits a message “Req_Verify,” including the UII of the RFID tag, the random number “RN16,” the security parameter “SecParam,” the encrypted random number “Ch16” and new random number “newRN16” received in operation 8, and the authentication data “Auth_data” received in operation 10, to the authentication server. Here, the communication between the RFID reader and the authentication server may be performed through a stable channel.

In operation 12, the authentication server verifies the authentication data “Auth_data” received from the RFID reader and transmits a result of whether the RFID tag has been successfully authenticated, to the RFID reader. The authentication server searches for a master key “K” related to the UII of the RFID tag and induces a session key from the random number “RN16” and the master key “K.” The authentication server decrypts the encrypted random number “Ch16” and new random number “newRN16” by using the session key to search for the random number “RN16” and the new random number “newRN16.” The authentication server performs an XOR operation on the random number “Ch16” and the new random number “newRN16” and encrypts the result of the XOR operation to obtain authentication data “Auth-data.” If the authentication data “Auth_data” obtained by the authentication server is equal to the authentication data “Auth_data” received from the RFID reader, the authentication server determines that the RFID tag has been successfully authenticated. If not, the authentication server determines that the RFID tag has not been successfully authenticated. The authentication server transmits the determination result to the RFID reader. The determination result of the authentication of the RFID tag includes an authentication success “Yes,” or an authentication failure “No,” and the UII.

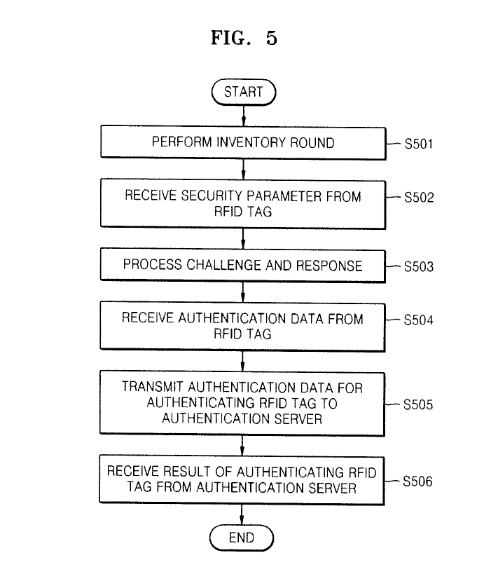

FIG. 5 is a schematic flowchart of a method by which an RFID reader authenticates an RFID tag, according to an embodiment of the present invention. The RFID tag is a security tag including a security parameter and has a master key. The RFID reader does not have information about the master key of the RFID tag, and an authentication server has the information about the master key of the RFID tag.

In operation S501, the RFID reader performs an inventory round with the RFID tag, which has generated a session key based on the master key and a first random number, to identify the RFID tag. The RFID reader transmits a query message to the RFID tag to start the inventory round and receives the first random number from the RFID tag. The RFID reader receives the first random number as an acknowledgement (ACK) message and receives tag information from the RFID tag. The tag information includes a UII, a PC, and an XPC.

In operation S502, the RFID reader requests the RFID tag to transmit the security parameter and receives a security parameter response from the RFID tag. The security parameter response includes the security parameter as plaintext.

In operation S503, the RFID reader transmits a challenge to the RFID tag and receives a challenge-response from the RFID tag. The challenge transmitted from the RFID reader includes plaintext challenge number and the first random number as a handle, and the challenge-response transmitted from the RFID tag includes a challenge random number and a second random number which are encrypted using a session key.

In operation S504, the RFID reader requests the RFID tag to transmit authentication data and receives an authentication data response from the RFID tag. The request of the RFID reader for the authentication data includes the second random number of the challenge-response encrypted by the session key as a handle, and the authentication data response includes authentication data which is obtained by encrypting a result of an XOR operation performed on the challenge number of the challenge and the second random number by using the session key.

In operation S505, the RFID reader requests the authentication server to verify the authentication data. In operation S506, the RFID reader receives a result of authenticating the RFID tag from the authentication server. The request for verifying the authentication data includes the UII, the first random number, the security parameter, the encrypted challenge random number, the encrypted second random number, and the authentication data. The authentication server determines whether authentication data generated based on pre-stored information about the master key of the RFID tag is equal to the authentication data which is generated by the RFID tag and received from the RFID reader, to determine whether the RFID tag has been successfully authenticated.

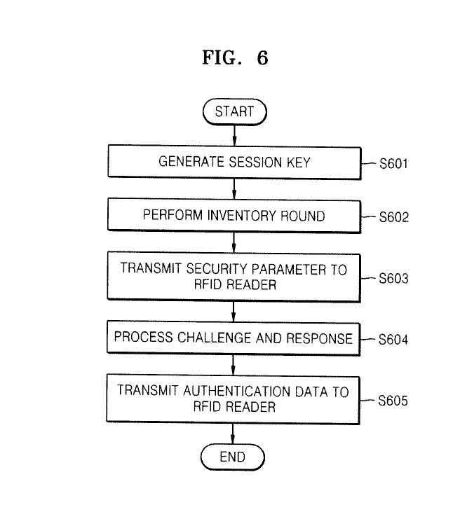

FIG. 6 is a schematic flowchart of a method by which an RFID tag is authenticated by an RFID reader, according to another embodiment of the present invention. The RFID tag is a security tag including a security parameter and has a master key. The RFID reader does not have information about the master key of the RFID tag, and an authentication server has the information about the master key of the RFID tag.

In operation S601, the RFID tag generates a session key based on the master key and a first random number. The RFID tag generates a random number and generates the session key by using the master key and the generated random number.

In operation S602, the RFID tag performs an inventory round with the RFID reader to transmit tag identification information to the RFID reader. The RFID tag receives a query message from the RFID reader to start the inventory round and transmits the first random number to the RFID reader. The RFID tag receives an ACK message that the RFID reader has received the first random number, from the RFID reader and transmits tag information to the RFID reader. The tag information includes a UII, a PC, and an XPC.

In operation S603, the RFID tag receives a request for the security parameter and transmits the security parameter to the RFID reader.

In operation S604, the RFID tag receives a challenge from the RFID reader and transmits a challenge-response to the RFID reader. The RFID tag receives the challenge including a plaintext challenge random number from the RFID reader and transmits the challenge response, including the plaintext challenge random number and a second random number, which are encrypted using the session key, to the RFID reader.

In operation S605, the RFID tag receives a request for authentication data from the RFID reader, generates the authentication data, and transmits the authentication data to the RFID reader. The RFID tag transmits an authentication data response to the request including the encrypted second random number. The authentication data response includes authentication data which is obtained by encrypting a result of an XOR operation performed on the challenge random number and the second random number by using the session key.

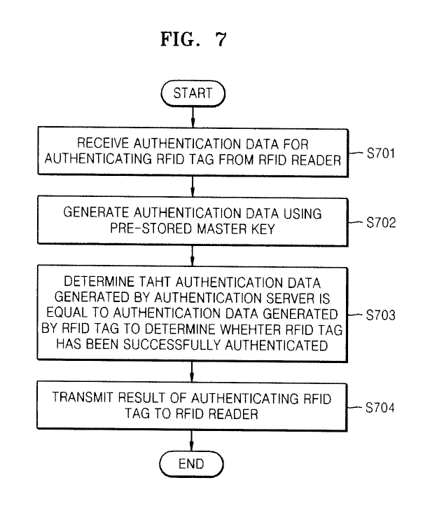

FIG. 7 is a schematic flowchart of a method by which an authentication server including information about a master key of an RFID tag supports an RFID reader to authenticate the RFID tag having the master key, according to an embodiment of the present invention. The RFID tag is a security tag including a security parameter and has a master key. The RFID reader does not have information about the master key of the RFID tag, but the authentication server has the information about the master key of the RFID tag.

In operation S701, the authentication server receives a request for verifying authentication data from the RFID reader. The request includes a UII of the RFID tag, a first random number which is used by the RFID tag to generate a session key, the security parameter of the RFID tag, an encrypted challenge random number included in a challenge-response which is generated by the RFID tag, an encrypted second random number, and the authentication data.

In operation S702, the authentication server generates its authentication data based on pre-stored information about the master key of the RFID tag. The authentication server searches for a master key related to the UII and generates the session key based on the searched master key and the first random number. The authentication server decrypts the encrypted challenge random number and the encrypted second random number by using the generated session key and encrypts a result of an XOR operation performed on the decrypted challenge random number and the decrypted second random number.

In operation S703, the authentication server determines whether its authentication data is equal to authentication data generated by the RFID tag to determine whether the RFID tag has been successfully authenticated. If the authentication data generated by the authentication server is equal to the authentication data generated by the RFID tag, the authentication server determines that the RFID tag has been successfully authenticated. If not, the authentication server determines that the RFID tag has not been successfully authenticated. The authentication server transmits the determination result to the RFID reader.

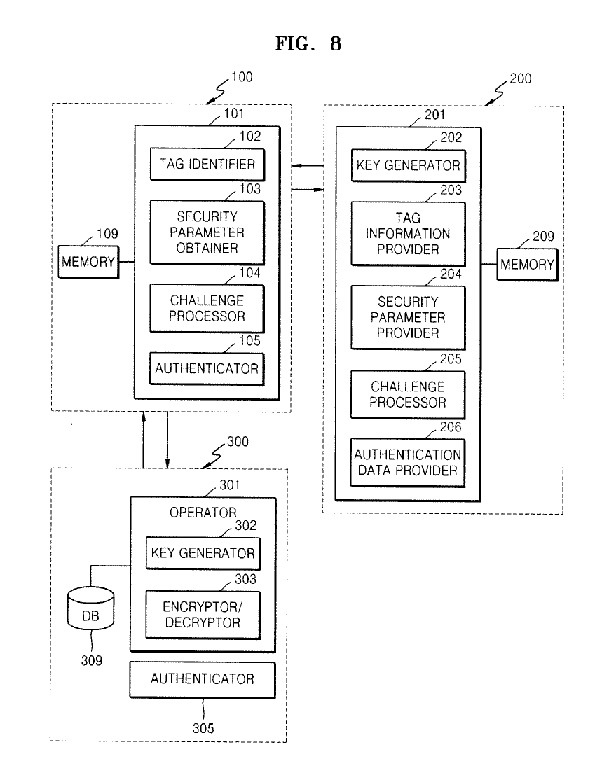

FIG. 8 is a schematic block diagram of entities of an RFID system by which an RFID reader authenticates an RFID tag by using an authentication server, according to an embodiment of the present invention.

Hereinafter, detailed descriptions of contents overlapping with the above descriptions will be omitted.

Referring to FIG. 8, the RFID system may be an RFID system having a 900 MHz-band wireless interface which is defined in ISO/IEC 18000-6 Type C and includes an RFID reader 100, an RFID tag 200, and an authentication server 300.

The RFID reader 100 communicates with the RFID tag 200 to check an authenticity of the RFID tag 200. The RFID reader 100 may communicate with an RFID tag having a security function and an RFID tag not having a security function. The RFID reader 100 does not have a master key and thus does not directly authenticate the RFID tag 200 but authenticates the RFID tag 200 by using the authentication server 300. The RFID reader 100 may be a reader in a store, a portable reader (e.g., a reader installed in a cellular phone) of a consumer, or the like. The RFID reader 100 includes a reader controller 101 and a memory 109. The reader controller 101 includes a basic protocol and a security protocol according to the present invention and executes a protocol depending on a type of an RFID tag. The basic protocol is used to communicate with an RFID tag not having a security function, e.g., the basic protocol may be a protocol which complies with ISO/IEC 18000-6 Type C. The reader controller 101 includes a tag identifier 102, a security parameter obtainer 103, a challenge processor 104, and an authenticator 105.

The tag identifier 102 performs an inventory round with the RFID tag 200 to identify the RFID tag 200. The tag identifier 102 generates a query message, transmits the query message to the RFID tag 200, and receives a first random number as a response from the RFID tag 200. The tag identifier 102 generates an ACK message that the RFID reader 100 has received the first random number, transmits the ACK message to the RFID tag 200, and receives a response including a UII, a PC, and an XPC from the RFID tag 200. The security parameter obtainer 103 generates a request for the security parameter, and transmits the request to the RFID tag 200, and receives a security parameter response from the RFID tag to obtain the security parameter. The challenge processor 104 generates a challenge, transmits the challenge to the RFID tag 200, and receives a challenge-response from the RFID tag 200. The challenge processor 104 generates a challenge random number of 16 bits and transmits the challenge including the challenge random number to the RFID tag 200. The authenticator 105 generates an authentication data request, transmits the authentication data request to the RFID tag 200, and receives an authentication data response from the RFID tag 200 to obtain authentication data. The authenticator 105 generates an authentication data verifying request, transmits the authentication data verifying request to the RFID tag 200, and receives a verified response from the RFID tag 200 to perform an authentication with respect to the RFID tag 200. The memory 109 stores a program for controlling an operation of the RFID reader 100, data generated by the RFID reader 100, and data received from the RFID tag 200. For example, the memory 109 may be one of various types of volatile memory which temporarily stores data while power is supplied.

The RFID tag 200 is a security tag which is compatible with an existing standard passive RFID tag, includes a security parameter to have an enhanced security function, and shares the master key with the authentication server 300. The RFID tag 200 includes a tag controller 201 and a memory 209. The tag controller 201 includes a key generator 202, a tag information provider 203, a security parameter provider 204, a challenge processor 205, and an authentication data provider 206.

The key generator 202 generates a session key based on the master key and the first random number generated by a random number generator (not shown). The tag information provider 203 generates a response, including the first random number of 16 bits, with respect to the query message received from the RFID reader 100, generates a response, including a UII, a PC, and an XPC, with respect to the ACK message that the RFID reader 100 has received along with the first random number, wherein the ACK message is received from the RFID reader 100, and transmits the responses to the RFID reader 100. The security parameter provider 204 generates a security parameter response, including the security parameter, with respect to the security parameter request received from the RFID reader 100 and transmits the security parameter response to the RFID reader 100. The challenge processor 205 transmits a challenge-response, including a second random number of 16 bits and a challenge random number which have been encrypted, with respect to the challenge received from the RFID reader 100, to the RFID reader 100. The authentication data provider 206 generates authentication data in response to the authentication data request received from the RFID reader 100 and transmits an authentication data response including authentication data to the RFID reader 100.

The authentication server 300 communicates with the RFID reader 100 through a predetermined channel, which may be regarded as a kind of web server access. The authentication server 300 shares the master key with the RFID tag 200. The authentication server 300 includes an operator 301, an authenticator 305, and a database (DB) 309.

The operator 301 receives the request for verifying the authentication data generated by the RFID tag 200 from the RFID reader 100 and generates its own authentication data based on pre-stored information about the master key of the RFID tag 200. The operator 301 receives the UII, the first random number used by the RFID tag 200 to generate the session key, the security parameter of the RFID tag 200, the encrypted challenge random number included in the challenge-response of the RFID tag 200, the encrypted second random number, and the authentication data generated by the RFID tag 200, from the RFID reader 100. The operator 301 includes a key generator 302 and an encryptor/decryptor 303. The key generator 302 searches the DB 309 for a master key corresponding to the UII of the RFID tag 200 and generates a session key based on the searched master key and the first random number. The encryptor/decryptor 303 decrypts the encrypted challenge random number and the encrypted second random number and encrypts a result of an XOR operation performed on the decrypted challenge random number and the decrypted second random number. The authenticator 305 determines whether the authentication data generated by the operator 301 is equal to the authentication data generated by the RFID tag 200. If the authentication data generated by the operator 301 is equal to the authentication data generated by the RFID tag 200, the authenticator 305 determines that the RFID tag 200 has been successfully authenticated. If not, the authenticator 305 determines that the RFID tag 200 has not been successfully authenticated. The authenticator 305 transmits the determination result to the RFID reader 200. In other words, the authentication server 300 transmits only the determination result to the RFID reader 200 based on given information.

A method of authenticating an RFID tag according to the present invention may be applied in a store such as a meat shop. An RFID reader in the store stably communicates with an authentication server. However, if the RFID reader in the store knows about a master key of the RFID tag (an RFID tag attached to a beef pack in the case of the meat shop), the RFID reader may abuse the master key. Thus, the RFID reader in the store should not know about the master key to prevent this abuse. Since a consumer should check whether the RFID tag is a normal tag, the RFID tag should be authenticated by using the RFID reader in the store or by using a portable reader of the consumer. In other words, in the method of the present invention, an arbitrary RFID reader can receive a result of whether an RFID tag has been authenticated, from an authentication server.

In the present invention, a UII is provided as plaintext to all RFID readers. In other words, the present invention may be used in an application which does not demand that an RFID reader should be authenticated. However, it may be important to consider authentication of an RFID tag. The RFID tag generates authentication data including a challenge, which is generated by and transmitted from the RFID reader, encrypts the authentication data, and transmits the encrypted authentication data to the RFID reader. Thus, if a value verified by an authentication server is an accurate value, it is considered that the RFID tag uses an accurate session key. Since the accurate session key is induced from an accurate master key, it is determined that the master key of the RFID tag is equal to a master key of the authentication server. Thus, the RFID tag is authenticated as a valid tag.

The RFID tag generates authentication data including a challenge received from an RFID reader, encrypts the authentication data, and transmits the authentication data to the RFID reader. If an RFID reader of a consumer tries to authenticate the RFID tag, the RFID reader changes the challenge to authenticate the RFID tag. Thus, the RFID reader detects spoofing caused by a replay of the RFID tag.

As described above, in a method and a system for authenticating an RFID tag, an RFID reader does not know about a master key of the RFID tag and receives a verification of reliability of tag information from the authentication server. Thus, the RFID reader cannot attack as a wicked insider and can check whether the RFID tag has been authenticated.

An efficient protocol having a relatively simple structure is provided.

The RFID tag is compatible with ISO/IEC 18000-6 Type C and thus does not affect any existing system. An infrastructure is established to authenticate the RFID tag.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to embodiments thereof, it will be understood by those skilled in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of authenticating an RFID (radio frequency identification) tag having a master key by an RFID reader, comprising:
requesting the RFID tag to transmit a security parameter and receiving a security parameter response from the RFID tag, wherein the RFID tag generates a session key based on the master key and a first random number,;
transmitting a challenge to the RFID tag and receiving a challenge-response from the RFID tag; and
requesting the RFID tag to transmit authentication data and receiving an authentication data response from the RFID tag.

2. The method of claim 1, before requesting the RFID tag to transmit the security parameter, further comprising:
transmitting a query message to the RFID tag and receiving the first random number from the RFID tag; and
sending an ACK (acknowledgement) message comprising the first random number to the RFID tag and receiving tag information comprising a UII (unique item identification), a PC (protocol control), and a XPC (extended protocol control) from the RFID tag.

3. The method of claim 1, wherein the challenge comprises a plaintext type challenge random number, and the challenge-response comprises the plaintext type challenge random number and a second random number, which are encrypted using the session key.

4. The method of claim 1, wherein the request for the authentication data comprises the second random number, and the authentication data response comprises authentication data, wherein the second random number is comprised in the challenge-response and encrypted using the session key, wherein the authentication data response is obtained by encrypting a result of an XOR (exclusive OR) operation performed on the challenge random number and the second random number, which are comprised in the challenge, by using the session key.

5. The method of claim 1, further comprising requesting an authentication server to verify the authentication data and receiving a verified response from the authentication server, wherein the authentication server comprises information about the master key of the RFID tag.

6. The method of claim 5, wherein the authentication server determines whether the RFID tag has been successfully authenticated based on whether authentication data generated by the authentication server based on the information about the masker key of the RFID tag is equal to authentication data generated by the RFID tag.

7. The method of claim 5, wherein the request for verifying the authentication data comprises the UII of the RFID tag, the first random number, the security parameter, the challenge random number and the second random number which are encrypted using the session key and comprised in the challenge, and the authentication data.

8. A method of authenticating in RFID environment, wherein a RFID tag having a master key is authenticated by an RFID reader, the method comprising:
generating a session key based on the master key and a first random number;
receiving a security parameter request from the RFID reader and transmitting a security parameter to the RFID reader;
receiving a challenge from the RFID reader and transmitting a challenge-response to the RFID reader; and
receiving an authentication data request from the RFID reader and generating authentication data.

9. The method of claim 8, before receiving the security parameter request from the RFID reader, further comprising:
receiving a query message from the RFID reader and transmitting the first random number to the RFID reader; and
receiving an ACK message comprising the first random number from the RFID and transmitting tag information including a UII, a PC, and a XPC to the RFID reader.

10. The method of claim 8, wherein the challenge comprises a plaintext type challenge random number, and the challenge-response comprises the plaintext type challenge random number and a second random number, which are encrypted using the session key.

11. The method of claim 8, wherein the authentication data request comprises the second random number which is comprised in the challenge-response and encrypted using the session key, and the authentication data response comprises authentication data which is obtained by encrypting a result of an XOR operation performed on the plaintext type challenge random number of the challenge and the second random number by using the session key.

12. The method of claim 8, wherein the authentication server determines whether the RFID tag has been successfully authenticated based on whether authentication data generated by the authentication server based on the information about the master key of the RFID tag is equal to authentication data generated by the RFID tag.

13. A method by which an authentication server comprising information about a master key of an RFID tag supports an RFID reader to authenticate the RFID tag having the master key, comprising
receiving at the authentication server a request to verify authentication data from the RFID reader, wherein said authentication data is generated by the RFID tag,;
generating authentication data based on the information about the master key; and
determining whether the RFID tag has been successfully authenticated based on whether authentication data generated by the authentication server is equal to authentication data generated by the RFID tag.

14. The method of claim 13, wherein the request comprises a UII of the RFID tag, a first random number used by the RFID tag to generate a session key, a security parameter of the RFID tag, an encrypted challenge random number and an encrypted second random number which are comprised in a challenge-response generated by the RFID tag, and the authentication data.

15. The method of claim 14, wherein the generation of the authentication data at the authentication server comprises:
searching for the master key related to the UII and generating the session key based on the searched master key and the first random number;
decrypting the encrypted challenge number and the encrypted second random number using the session key; and
encrypting a result of an XOR operation, which is performed on the decrypted challenge random number and the decrypted second random number, by using the session key.

16. An RFID reader authenticating an RFID tag having a master key, comprising:
a security parameter obtainer which requests the RFID tag to transmit a security parameter and receives a security parameter response, wherein the RFID tag generates a session key based on the master key and a first random number,;
a challenge processor which transmits a challenge to the RFID tag and receives a challenge-response; and
an authenticator which requests the RFID tag to transmit authentication data and receives an authentication data response.

17. The RFID reader of claim 16, further comprising a tag identifier which receives the first random number as a response to a query message transmitted to the RFID tag and receives a response comprising a UII, a PC, and an XPC with respect to an ACK (acknowledgement) message that the RFID reader has received along with the first random number, from the RFID tag.

18. The RFID reader of claim 16, wherein the challenge comprises a plaintext type challenge random number, and the challenge-response comprises the plaintext type challenge random number and a second random number, which are encrypted using the session key.

19. The RFID reader of claim 16, wherein the request for authentication data comprises the second random number which is comprised in the challenge-response and encrypted using the session key, and the authentication data response comprises authentication data which is obtained by encrypting a result of an XOR operation performed on the plaintext type challenge random number of the challenge and the second random number, using the session key.

20. The RFID reader of claim 16, wherein the authenticator requests an authentication server comprising information about the master key of the RFID tag to verify authentication data and receives a verified response from the authentication server.

21. An RFID tag having a master key, comprising:
a key generator which generates a session key based on the master key and a first random number;
a security parameter provider which generates a security parameter in response to a security parameter request received from the RFID reader;
a challenge processor which generates a challenge-response to a challenge received from the RFID reader; and
an authentication data provider which provides authentication data in response to an authentication data request received from the RFID reader.

22. The RFID tag of claim 21, further comprising a tag information provider which generates a response comprising the first random number with respect to a query message received from the RFID reader and provides the RFID reader with a response comprising a UII, a PC, and an XPC with respect to an ACK message that the RFID reader has received along with the first random number.

23. The RFID tag of claim 21, wherein the challenge-response comprises a challenge random number included in the challenge and a second random number which are encrypted using the session key, and the authentication data response comprises a result obtained by performing XOR operation on the challenge random number and the second random number, wherein the XOR operation is encrypted using the session key.

24. An authentication server supporting an RFID reader to authenticate an RFID tag having a master key, comprising:
an operator which receives a request for verifying authentication data generated by the RFID tag from the RFID reader and generates authentication data based on pre-stored information about the master key of the RFID tag; and
an authenticator which determines whether the RFID tag has been successfully authenticated based on whether the authentication data is equal to authentication data generated by the RFID tag.

25. The authentication server of claim 24, wherein the request comprises a UII of the RFID tag, a first random number used by the RFID tag to generate a session key, a security parameter of the RFID tag, an encrypted challenge random number and an encrypted second random number which are comprised in a challenge-response generated by the RFID tag, and the authentication data.

26. The authentication server of claim 25, wherein the operator comprises:
a key generator which generates a session key based on the master key searched based on the UII and the first random number; and
an encryptor/decryptor which decrypts the encrypted challenge random number and the encrypted second random number and encrypts a result of an XOR operation performed on the decrypted challenge random number and the decrypted second random number.
